(19) United States
(12) Patent Application Publication
(10) Pub. No.: US 2006/0125323 A1
(43) Pub. Date: Jun. 15, 2006

(54) Passive infrared switch

(76) Inventors: Michael Ostrovsky, Brooklyn, NY (US); Paul Soccoli, New Hyde Park, NY (US); Alfred J. Lombardi, Syosset, NY (US); John Libretto, North Massapequa, NY (US)

Correspondence Address: PAUL J. SUTTON, ESQ., BARRY G. MAGIDOFF, ESQ.;GREENBERG TRAURIG, LLP, 200 PARK AVENUE, NEW YORK, NY, 10166, US

(21) Appl. No.: 11/182,369

(22) Filed: Jul. 15, 2005

Related U.S. Application Data
(60) Provisional application No. 60/591,274, filed on Jul. 27, 2004.

(51) Int. Cl. H01H 47/26; G08B 13/18

(52) U.S. Cl. 307/117; 340/567

(57) ABSTRACT

A passive infrared (PIR) wall switch is operable in a two-wire circuit to control power to a load. The PIR wall switch can include one or more PIR sensors with a low current two stage amplifier-filter. The PIR sensor(s) monitor infrared (IR) radiation. The amplifier can provide a pulse signal when an IR radiation level has changed. Power for control circuitry of the PIR switch may be derived from a ground leakage type power supply, which can supply phase line wire leakage current to ground of less than 0.5 milliampere.

This application claims the benefit of the filing date of a provisional application having Ser. No. 60/591,274, which was filed on Jul. 27, 2004.

### BACKGROUND OF THE INVENTION

1. Field of the Invention

This invention relates generally to passive infrared (PIR) switches.

2. Description of the Prior Art

A passive infrared (PIR) occupancy switch is a device that can be used to replace a single-pole-single-throw (SPST) switch including standard mechanical wall switches found in many homes and businesses. The PIR switch detects infrared energy due to motion in an area. Control circuitry in the PIR switch operates to open or close contacts of a relay to disconnect or connect power to a load, such as a lighting circuit, based on the level of infrared energy detected.

The PIR switch can be used in a two-wire system. That is, power can be received from a phase line and can be coupled through the relay contacts to a phase load line. A neutral (or return) wire may not be available. When the switching relay contacts are closed, the phase line and phase load lines are connected to provide power to the load. There is no voltage between the phase and the load lines. Thus, power between the phase line and phase load lines is not available to drive the PIR control circuitry when the relay contacts are closed because the relay contacts short circuit the control circuitry.

Power for the control circuitry can be provided between the phase line wire and ground. Safety considerations can limit the amount of current that may be drawn between the phase line wire and ground. Two-wire electrical control devices, other than PIRs, that switch power across a load when energized may have similar power considerations. That is, when the switched contacts are in a low impedance state as occurs when the relay contacts are closed, the voltage across the device drops from an alternating current (AC) line voltage to almost zero. Thus, when the control device is ON (energized), no power is available to drive the switching control circuitry.

One solution utilizes a technique whereby a small amount of current is purposely leaked to ground to drive the control circuitry when power is switched to the load. The switching control circuitry, if designed to draw only a small amount of current (compared to the load circuitry), can derive the power it needs to operate from this ground leakage current. When leakage current is used to operate switching/control circuitry, Underwriters Laboratory (UL) requires that the current not exceed a value of 0.5 milliampere (mA) (500 microamperes (μA)). Circuits which satisfy this limitation can be difficult to implement.

U.S. Pat. No. 5,786,644 ('644) assigned to Leviton Manufacturing Co., Inc., assignee of the present disclosure, discloses the use of an energy storage means such as a capacitor which uses ground leakage current to operate switching control circuitry of a passive infrared switch. Referring to FIG. 1 of '644, there is shown a two wire sensor 10 which includes switching means 18 settable to one of a high (e.g., open circuit) and a low (e.g., short circuit) impedance state in response to a switching signal from a PIR control 16 for connecting/disconnecting a source of AC power to/from an electrical load 22 such as a light. The switching means 18 is located in a main conduction path which provides power between the AC source and the load. The switching means is connected between a first leg of the AC source and a first terminal of the electrical load. The second terminal of the electrical load is connected to a second leg of the AC source. An energy storage means 14 for storing an electrical charge is electrically coupled to the first leg of the AC source and to the first terminal of the electrical load. A charge control means 12 is connected between the switching means and the energy storage means to regulate the voltage across the energy storage means and, therefore, the current flowing therein. When the contact in the switching means 18 is open, that is, in a non-conductive state, substantially no power is delivered to the load and substantially all of the AC source voltage appears across the circuit 10 because it has a relatively high impedance relative to the load 22. At this time leakage current is provided to and is stored in the energy storage device. When the contacts are closed, the power required to drive the PIR control circuit is obtained from the energy storage means. Circuitry for controlling the switching means is coupled across the energy storage means 14 and responds to detection (or sensing) of the monitored condition by generating the switching signal.

### SUMMARY OF THE DISCLOSURE

Techniques and methods are disclosed for a passive infrared (PIR) wall switch that is operable in a two-wire circuit to control power to a load. The PIR wall switch can include one or more PIR sensors with a low current two stage amplifier-filter. The PIR sensor(s) monitor infrared (IR) radiation. The amplifier can provide a pulse signal when an IR radiation level has changed, for example, because of motion in a surrounding area. Power for control circuitry of the PIR switch may be derived from a ground leakage type power supply, which can supply phase wire leakage current to ground of less than 0.5 milliampere.

The passive infrared switch can be used in a two wire system and includes a relay switch coupled to control the flow of power to a load. A passive infrared control circuit can be coupled to operate the relay switch upon detecting a change of infrared radiation. A power supply is coupled to supply a current not greater than 0.5 mA to the passive infrared control circuit.

Some of the implementations of the disclosed techniques may include one or more of the following advantages. The PIR wall switch can continue to operate in a two-wire system that supplies phase current to a load wire when the switch is energized (closed). The PIR switch can use a power supply, which supplies a current no greater than 0.5 mA to the PIR circuitry, which may be drawn from the phase wire to ground. The 0.5 mA limit can avoid a potentially hazardous condition.

The above-stated and other advantages of the invention will become apparent from the following detailed description when taken with the accompanying drawing. It will be understood, however, that the drawing is for the purpose of illustration and is not to be construed as defining the scope or limits of the invention, reference being had for the latter purpose to the claims appended hereto.

### BRIEF DESCRIPTION OF THE DRAWINGS

Features and advantages of the present invention will be more readily understood upon consideration of the following detailed description of a preferred embodiment of the invention when taken in conjunction with the following drawings wherein like parts are represented by similar reference numbers.

FIG. 1 is a functional block diagram of a prior art PIR occupancy sensor which utilizes a rechargeable energy storage device to operate the switching circuit;

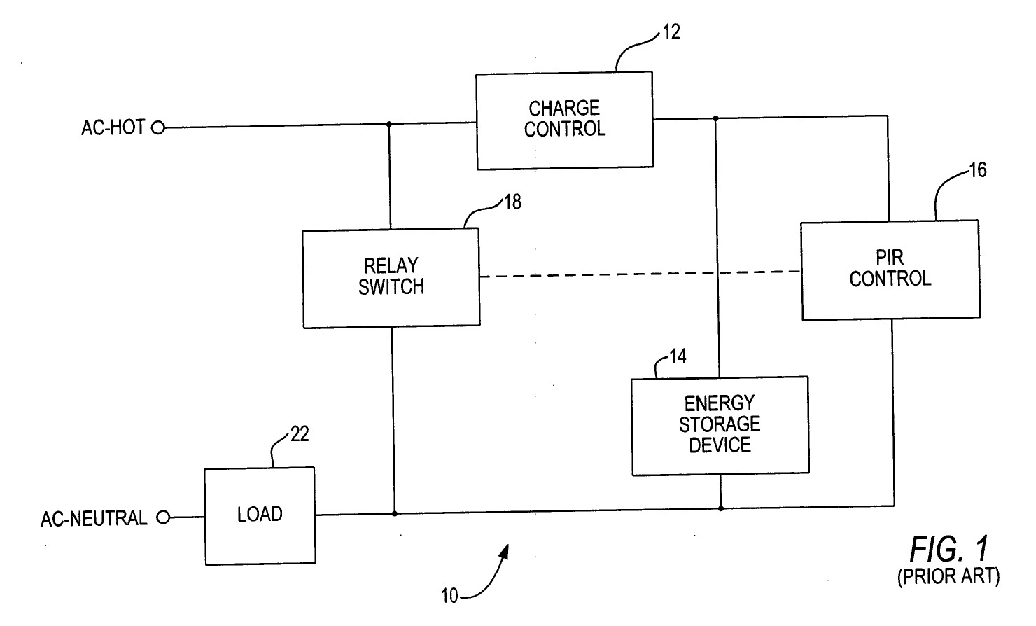

FIG. 2 is a functional block diagram of a PIR wall switch for use in a two wire system which has a ground leakage current type power supply;

FIG. 3 is a schematic diagram of a ground leakage current type of power supply for use with the PIR wall switch of FIG. 2 to operate the switching circuit; and

FIG. 4 is a schematic diagram of a modification of the ground leakage current type of power supply of FIG. 3 which provides a zero crossing signal output.

### DETAILED DESCRIPTION

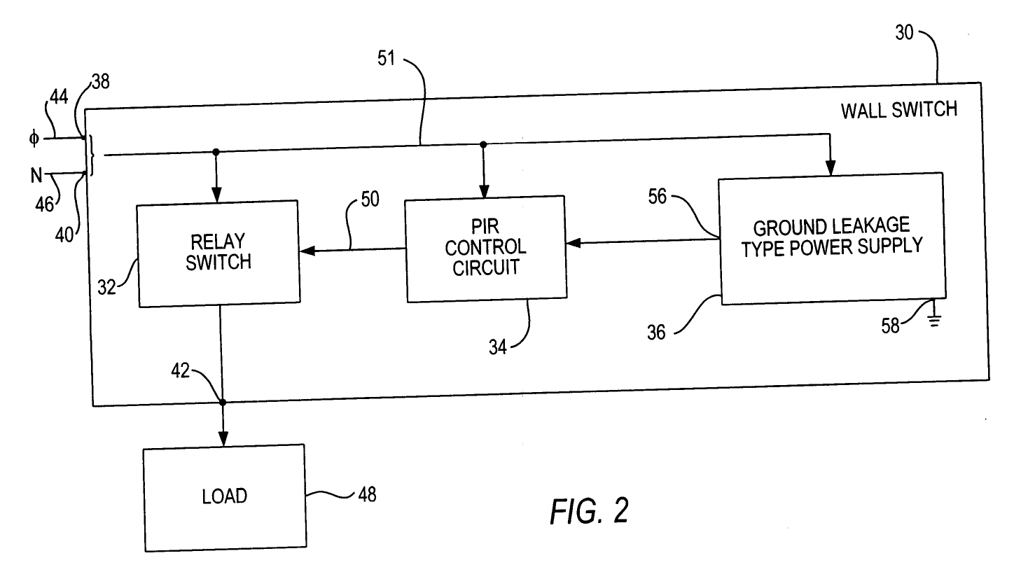

Referring to FIG. 2, there is shown a functional block diagram of a PIR wall switch for use in a two wire system which has a ground leakage current type power supply which provides a leakage current of no greater than the 0.5 mA for operating the PIR control. The wall switch 30 includes a switching device 32, a PIR control circuit 34 and a ground leakage current type power supply circuit 36. The wall switch can have three terminals 38, 40, 42. Terminal 38 is connected to the phase conductor 44 of an AC power source and terminal 40 is connected to the neutral conductor 46 of the AC power source. A load, such as a lamp 48, is connected to output terminal 42, which can have two conductors and is connected through at least one set of contacts in a switching device such as relay switch 32 to the phase and neutral conductors 44, 46. The state of switching device 32 (conducting or non-conducting) controls the flow of power to the load 48 and is controlled by the PIR control circuit 34. Thus, switching device 32 can be selectively set to either of two states, conducting (ON or low impedance) or non-conducting, (OFF or “high impedance”) states which correspond to the closed or open contact states of the device. Relay switch 32 can be a conventional latching type relay which consumes pulse power only during switching periods and consumes no power at other times.

PIR control circuit 34, is electrically coupled by conductor 50 to control the operation of relay switch 32 and is connected to the AC power terminals 38, 40. The PIR control circuit monitors an area for a predetermined condition and generates a signal when the predetermined condition occurs. The sensor of the PIR control circuit can be preferably a passive infrared (PIR) control sensor to provide an occupancy sensing function. The sensor comprises conventional circuitry well known to those skilled in the art and the state of the relay switch is defined by the sensor in accordance with the amount of infrared energy detected by the PIR.

When the contact in relay switch 32 is in its open state, (that is, a non-conductive state), substantially no power is delivered to the load 48. A majority of the AC source voltage on conductors 44, 46 appears across the contacts 38, 40 of the wall switch 30 while the relay switch 32 is non-conductive because it has a relatively high impedance relative to the load 48. However, current is provided both to the ground leakage type of power supply 36 and the PIR control circuit 34 by conductor 51, which is coupled to terminals 38, 40.

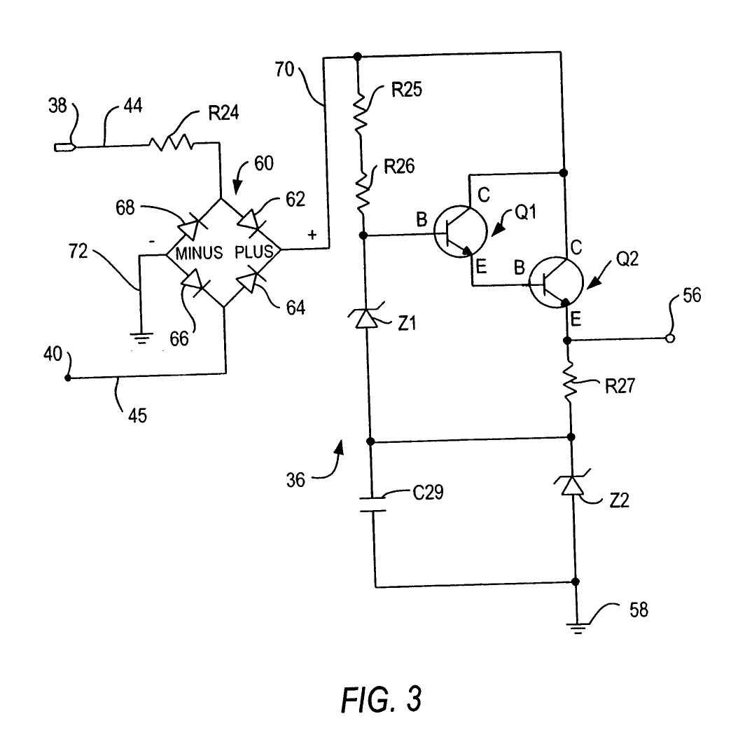

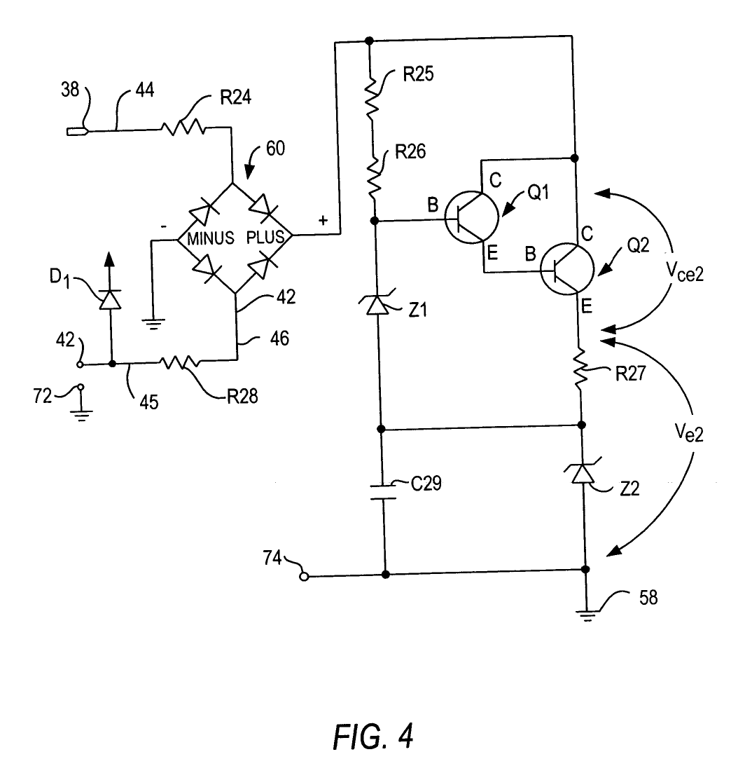

The ground leakage type of power supply 36 has input terminals connected to the phase conductor 44 by terminal 38 and the neutral conductor 46 by terminal 40 of the wall switch. A terminal 56 of the ground leakage type of power supply 36 is connected to provide power to the PIR control circuit 34, and terminal 58 of the ground leakage type power supply is connected to the building ground which can be the system ground or reference point for the switch circuitry. Ground leakage type of power supply 36 is more fully disclosed in FIGS. 3 and 4.

Referring to FIG. 3, there is shown a ground leakage type power supply which has a leakage current which does not exceed 0.5 mA for use in the two wire (that is, no neutral) system herein disclosed. The ground leakage type of power supply shown here is disclosed as a Constant Current Supply Over A Wide Range Of Input Voltages in U.S. Pat. No. 6,031,750 which is assigned to Leviton Manufacturing Co., Inc., the assignee of the instant application, and is incorporated herein in its entirety by reference. The ground leakage type power supply shown in FIG. 3 can supply a constant current of 0.5 mA for different input voltage levels which can vary from about 102 to 230 or more volts. An AC source is coupled to ground leakage type power supply 36 by phase input terminal 38 and neutral input terminal 40. The AC line voltage is fed to a bridge 60 including diodes 62, 64, 66 and 68 to produce a DC voltage signal. The anode of diode 62 can be coupled to the cathode of diode 68 and the AC conductor 44. A resistor R24 can be in conductor 44 to save some lost current in low current applications. The use of resistor R24 is optional. The cathode of diode 62 is coupled to the cathode of diode 64 and to a conductor 70. The anode of diode 64 is coupled to the cathode of diode 66 and by conductor 45 and terminal 40 to the conductor 46 (FIG. 2). The anode of diode 66 is coupled to the anode of diode 68 and to a circuit ground terminal 72.

The DC level on conductor 70 is applied to two resistors R25 and R26 coupled in series to limit the current applied to the circuit and bias the base B of a transistor Q1. The base B of transistor Q1 also is connected to the cathode of a zener diode Z1. Transistor Q1 acts as an emitter follower and the emitter E of transistor Q1 is connected to the base B of a transistor Q2. Collectors C of transistors Q1 and Q2 are connected to conductor 70. The output at emitter E of transistor Q2 is coupled to a resistor R27. The transistors Q1 and Q2 are connected as a Darlington amplifier or cascaded emitter followers. Resistors R25 and R26 limit the voltage applied to zener diode Z1 to prevent burnout and limit current to the load. The output to the emitter E of transistor Q2 is applied to a first end of the output resistor R27 and a second end of resistor R27 is connected to the cathode of a zener diode Z2 and to ground 58 through a bypass capacitor C29. The use of the bypass capacitor C29 is optional. The anode of zener diode Z2 is coupled to the circuit ground 58.

The ground leakage type power supply 36 regulates the current through the resistor R27. The zener diode Z1 and the base B to emitter E voltage drop of transistors Q1 and Q2 determines the voltage across R27. The voltage on terminal 56 from the emitter E of transistor Q2 to ground 58 will be fixed.

As the input voltage at terminals 38 and 42 by conductors 44 and 46 to the bridge 60 increases above voltage Ve2, the extra voltage will be dropped across the collector C to emitter E of transistor Q2, this is voltage Vce2. Therefore, the same current will flow through resistor R27 for input voltages in the range of 102 to 400 volts. This allows the use of one terminal for phase power input and one terminal for the AC neutral to the ground leakage type power supply 36. The voltage applied to resistor R27 and which is on terminal 56 is used as an input to the PIR control circuit to power the Control circuitry. The ground leakage type power supply 36 limits the supply current to the PIR control circuit to 0.5 ma.

To limit the leakage current to this level, current is leaked from the input conductor 44 to the neutral line 45 or circuit ground, which can be the building ground. Ground point 58 is the system ground or reference point for the switchable circuitry. The acceptable level of leakage current is 0.5 mA and the ground leakage type power supply limits the current regardless of the load applied to it.

Referring to FIG. 4, there is shown a modification of the ground leakage type of power supply of FIG. 3 having a zero crossing signal output which is obtained by connecting to terminal 42 of conductor 45 a resistor R 28 having a high value of resistance, which can be connected from terminal 42 to the anode of diode D1. The zero crossing signal is read between terminal 42 and a ground terminal 72. The cathode of the diode D1 is connected to the regulated operating voltage at a regulated DC voltage taken from zener diode Z2. A system ground is available at terminal 74.

While there have been shown and described and pointed out the fundamental features of the invention as applied to the preferred embodiment, as is presently contemplated for carrying them out, it will be understood that various omissions and substitutions and changes in the form and details of the device described and illustrated and in its operation may be made by those skilled in the art, without departing from the spirit of the invention.

What is claimed is:

1. A passive infrared switch for use in a two wire system comprising:
a relay switch coupled to control the flow of power to a load;
a passive infrared control circuit coupled to operate the relay switch upon detecting a change of infrared radiation; and
a power supply coupled to supply a current not greater than 0.5 milliampere to the passive infrared control circuit.

2. The passive infrared switch of claim 1, wherein the power supply includes a ground leakage type power supply.

3. The passive infrared switch of claim 2, wherein the ground leakage type power supply is a constant current supply.

4. The passive infrared switch of claim 3, wherein the constant current supply includes a Darlington driver.

5. The passive infrared switch of claim 1, wherein the relay switch is adapted to receive a phase line wire and a phase load wire and, when the relay energized, couple the phase line wire to the phase load wire.

6. The passive infrared switch of claim 5, wherein, when the relay is energized, the current supplied by the power supply flows from the phase line wire to ground.

7. A method of providing power to a passive infrared switch comprising:
coupling an output of a ground leakage type power supply to a passive infrared control circuit;
limiting a ground current to the passive infrared control circuit to no greater than 0.5 milliampere;
controlling supply of alternating current to a load through a relay switch; and
operating the relay switch upon detecting a change of infrared radiation.
